(19) United States
(12) Patent Application Publication
(10) Pub. No.: US 2004/0034638 A1
(43) Pub. Date: Feb. 19, 2004

(54) Method for analyzing and characterizing the usage pattern of a device

(75) Inventors: William A. Brown, Raleigh, NC (US); Richard William Muirhead, Tyler, TX (US); Francis Xavier Reddington, Sarasota, FL (US)

Correspondence Address: Darcell Walker, Suite 250, 9301 Southwest Freeway, Houston, TX, 77074, US

(73) Assignee: INTERNATIONAL BUSINESS MACHINES CORPORATION, Armonk, NY

(21) Appl. No.: 10/199,245

(22) Filed: Jul. 18, 2002

(51) Int. Cl. G06F 17/30

(52) U.S. Cl. 707/10

(57) ABSTRACT

The present invention provides a method to analysis information collected in the form of a unique set of data that contains the operations of a device over a period of time. In this system, there is a can be a central or distributed depository of the statuses of all designated device attributes of a device including the past state history of the device. Each device on the system will transmit a state change notification to the central location each time the status of the device changes. This status change will be recorded in the central location storage. In the method of the present invention, analytical techniques are developed and applied to recorded data of the device status history. The analytical techniques can analyze the recorded data and produce a use pattern for a particular device based on the recorded information about the device. The first step in this method is to record status change information for a device. The next step is to formulate a query of the recorded data for a device. This query can include a particular characteristic of the data such as the amount of time the device is in the ‘on’ state during a predetermined time period. The third step is to apply analytical techniques to the data in accordance with the formulated query to get the desired information and results. These results could be part of a report on the operations of the device. The obtained information could be used to develop systems that will have a more efficient of device and appliances on the system.

### Field of the Invention

This invention relates to a method to analyze the usage of a device connected to a network and in particular to a method for analyzing and characterizing the usage of devices, located in a network contained in an environment such as a physical facility environment. The analysis would be applied to a unique set of device status data that contains an operational history of each device.

### Background of the Invention

Currently there is an increasing trend to automate various activities and tasks in our society. Industries such as the banking industry, the automotive industry, the oil and refining industry and the transportation industry use computers and automation to control machines and other various devices during the performance of many tasks and processes. The application of automation control systems has expanded from large industries to small businesses and residential homes.

Home automation systems, or home management systems as they are sometimes called, commonly provide for control of lighting, heating and air conditioning, window shades or curtains, pool heaters and filtration systems, lawn sprinklers, ornamental fountains, audio/visual equipment, and other appliances. Home automation systems are frequently integrated with a home security system so that when a fire alarm is raised, for example, the system will automatically turn on internal and external lights. Security systems frequently include lighting control and other types of home automation as an option. Many larger homes incorporate a home theater that requires a certain amount of automation for convenient operation and this automation is often extended to other parts of the dwelling. In farms, the automation system will also control outbuilding heating and lighting and warn of non-standard conditions in automated feeding machinery and other farm equipment.

Many different designs and configurations exist for automation systems. One form of automation system includes a central control unit that monitors environmental sensors and inputs from user controls and maintains a schedule of preprogrammed time-of-day and day-of-the week events. Inputs to the central control are provided by dedicated low-voltage wiring, for example, from door and window sensors, signals carried on power lines, RF signals, signals on existing telephone wiring and, occasionally, optical signals. The central control unit is controlled by a program that is either specifically built for the particular installation or a general-purpose program with a user interface that allows the owner or a technician employed by the owner to make certain types of modifications. The interfaces to these programs can be anything from strings of digits entered on standard touch-tone keypads, for example, Home Automation Inc.'s Omni Automation and Security System, to graphical user interfaces, for example, the Molex “Choices” software.

The communication between the central control unit and various devices on the system can be through a variety of protocols. The Echelon Corporation has built home automation and industrial control apparatus based on a signaling protocol they refer to as LonWorks that uses a network of nodes each of which has one or more microprocessors. Many systems are designed to operate in a “cooperative computing” environment in which the individual nodes maintain their own programs. Programming of the individual nodes can be done by downloading new software from a temporarily attached lap top computer or by downloading software over the LonWorks network. A similar approach has been implemented with the CEBus and has been used in many custom installations for larger homes and office buildings. The Consumer Electronics Bus (CEBus) provides the standard for creating products and devices to communicate with each other. This bus can bring intelligence into homes or any physical or virtual facility with smart products (aggregation of smart devices) in anticipating the needs if tomorrow's consumer.

In a home, there are many appliances/devices that are powered by electricity, either AC or DC. Current technology development is moving in the direction of more automated control of routine tasks performed by the devices. Although this trend is growing in the automation of device tasks and activities, there is very little if any interest in developing techniques to record the usage history of the devices for the purpose of altering the usage pattern such that the device is operating more efficiently and more economically for the facility owner. Some techniques that have been developed in this area are focused on energy generation, energy consumption and the selling of energy. However, currently there are no techniques to capture general operations of various types of devices used in a facility.

It is desirable to provide an automated system that has a central control unit that can monitor and record status changes of devices and can establish an operational history of devices on that system. It is another desire to have a means to examine the data contained in the use history of a device and generate usage patterns and other operational characteristics for a particular device.

### Summary of the Invention

It is an objective of the present invention to provide a method to monitor and record the status changes in the operation of devices in an environment such as a physical facility.

It is a second objective of the present invention to provide techniques that can be applied to stored information to analyze the past operations of the device.

It is a third objective of the present invention to generate usage patterns for a particular device in the system based on the stored record of the past operations of the device.

It is a fourth objective of the present invention to provide a method to characterize the usage of a device over a specified period of time.

The present invention provides a method to collect a unique set of data containing the operations of a device over a period of time. A state management system implemented in conjunction with the present invention provides a record of the statuses of all device attributes over a period of time and thereby generating for each device a state history for all attributes of the device. Since this status data is held in a persistent store across the intersecting subsystems data analysis and reporting is now possible. Transactional, workflow and security information for the state management activities are easily traceable and can be logged, analyzed and summarized through the generation of reports.

In a particular application, the data set will have an entry for each status change of the device. Each entry will contain status information on device parameters each time the status of the device changes. For example, each time the device changes from one status to another status. These device statuses include “on” and “off” status. This information can be stored in a central repository for all devices in the system. With the unique set device status information, analysis techniques can be applied to the data to generate new information not previously available about the performance of the device. This new analysis can provide for unique characterization of the device operations.

In the method of the present invention, analytical techniques are developed and applied to recorded device status history data. . The analytical techniques can analyze the recorded data and produce a device use pattern for a particular device based on the recorded information about the device. The first step in this method is to record status change information for a device. To perform this step, it is necessary to monitor the statuses of devices that operate in an environment such as a physical facility from a central location. There can be a central repository of the statuses of all designated device attributes. The device status information can include the past state history of the device. Each device on the system will transmit a state change notification to the central location each time the status of the device changes. This status change will be recorded in a location storage. The implementation of a centralized management configuration also provides each device, product and smart application a common interface to use when transmitting messages or information to other devices in the same facility of devices that are connected to the same central management location. This information can be stored in a storage location designated for that device. The next step is to formulate a query of the recorded data for a device. This query can include a particular characteristic of the data such as the amount of time the device is in the ‘on’ state during a predetermined time period. The third step is to apply analytical techniques to the data in accordance with the formulated query to get the desired information and results. These results could be part of a report on the operations of the device. The obtained information could be used to develop systems that will have a more efficient of device and appliances on the system.

### Brief Description of the Drawings

FIG. 1 is a configuration of components in a physical facility that implements the method and system of the present invention.

FIG. 2 illustrates an example of a process and data flow model of the analysis and reporting management system of the present invention.

FIG. 3 is a flow diagram of the steps in the method of the present invention.

FIG. 4 is an illustration of a storage configuration containing the devices and device statuses in accordance with implementations of the present invention.

FIG. 5 is an illustration of a storage configuration containing the devices and device statuses for an alternate device in accordance with implementations of the present invention.

### Detailed Description of the Invention

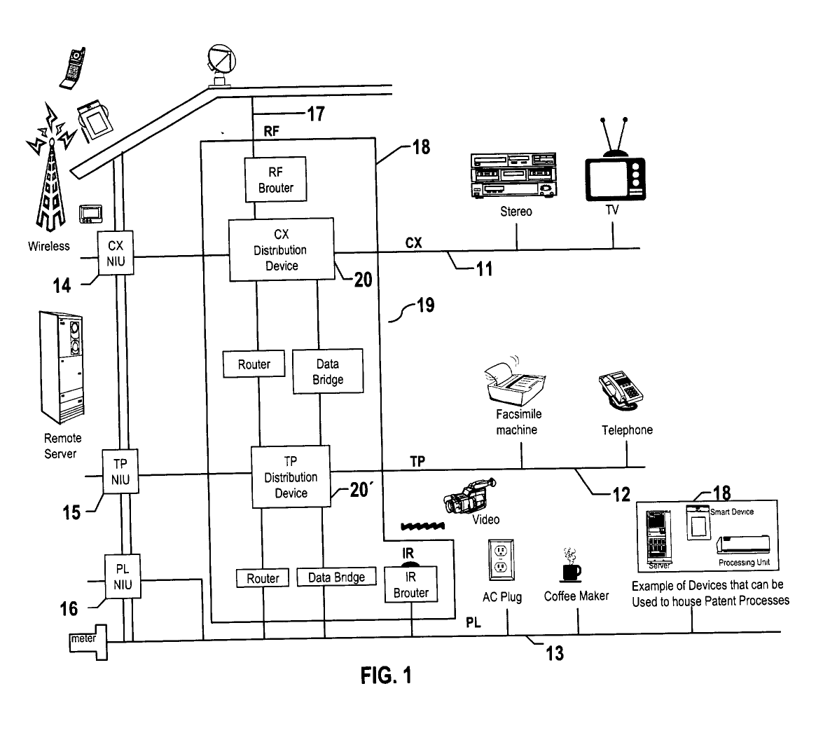

The present invention provides a method to collect a unique set of data containing the operations of a device over a period of time. In order to clearly illustrate the techniques in this invention, the description of this invention will be in the context of an application in a physical facility. However, the application of this invention encompasses applications in addition to the physical facility environment described herein. FIG. 1 is a configuration of components in the system of the present invention. In this configuration lines 11, 12 and 13 are various ways that energy can enter a facility to enable operations of the devices in the facility. Line 11 represents communications over a coaxial cable through a device such as a television set. Line 12 represents communications over twisted pair cables through a device such as a telephone. Line 13 represents the supply of energy through a standard power line wired into the facility to operate devices and appliances in the facility such as a coffee maker. These communication lines are physical and therefore have a physical entry into the facility. The physical entry points for the coaxial cable, twisted pair and power lines are represented by NIU boxes 14, 15, and 16 respectively. Also shown is an input medium using radio frequencies (RF) 17. Devices that communicate through this medium are remote devices/wireless devices that include devices such as cellular telephones. In the present invention, there would be a status of each device in facility regardless of the manner in which the device is powered or the manner in which the device communicates. The center of the activity is the state manager 18, which is a process that captures status information for the various devices and coordinates communications between the various devices in the facility. In addition, this state manager, using industry standard format, provides persistence to a data store and can transmits data to any device in the facility. Section 19 illustrates bridges and routes that provides communication links between the incoming information lines (11, 12, and 13), the distribution devices 20 and 20″ and the appliance devices.

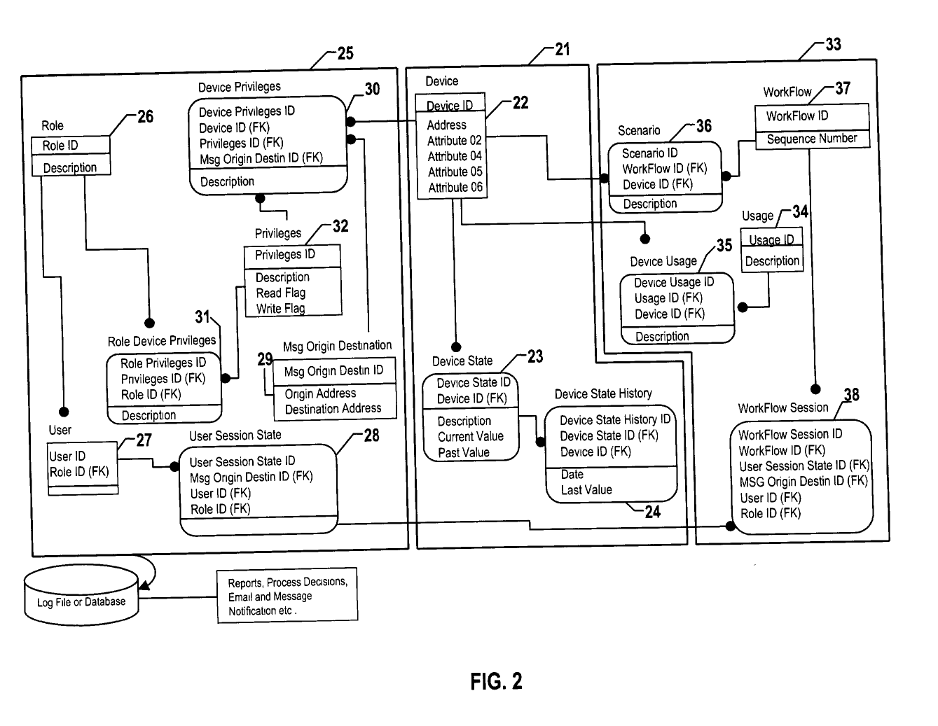

FIG. 2 represents the process and data flow model of the Analysis and Reporting Management system. Based on the fact state management is held in a persistent store across the intersecting subsystems this model provides the essential data infrastructure that applications need to analyze and report on any direct, derived, or summarized data. In addition other forms of analytical use of this data are now possible. This model reflects the core essential data infrastructure: 1) Device State, 2) Security on a Device and 3) Device Usage. This analytical model enables the generation of answers to the following core questions:

What the Device data values and status are ?

What The Device data value and status were ?

How the Device was accessed ?

How the Device data values and status was created ?

Who Accessed the Device(s) ?

Who Attempted to Access the Device(s) ?

Who Updated the Device(s) ?

Where was the Device(s) Accessed From ?

Where the Device(s) were Attempted to be Accessed From ?

How Many Time the Device(s) was Accessed ?

How the Device(s) was Accessed

When the Device(s) was Accessed ?

How the Device(s) are Used ?

How the Device(s) are Used Collaboratively ?

Multiple variations on the above questions and derived corresponding analysis could easily be achieved from these core questions, and their answers. The model can easily be understood from the following data management perspectives as illustrated in FIG. 2.

A system model for which analysis can be performed can contain three primary components: State Management, Security and Workflow Management. The state management component 21 is the basis and core for sub systems status (state), transition and event driven decision-making operations. This component maintains current status of devices and it past state history. It also offers the capacity to reset status in the event of an interruption in power or reversing an updating entry. The state management component 21 is a system that comprises a device 22, a device state 23 and a device state history 24.

The device 22 comprises attributes that define a device identity, the current data values of the device attributes, and the primary event driven operations of the device. A device 22 can also be an aggregation of smaller devices (i.e. sensors, components, etc.). The Device ID is a unique identifier of a device and or the sensor(s) or component(s) that in aggregation make up a device. An example of an aggregation device is a thermal sensor and a Thermostat consisting of thermal sensor, LED display. Both the sensor and the Thermostat are both considered devices, even though one may be part of the composition of another. A detailed description of the state management component 21 is included in a co-pending patent application number AUS920020055US1 to the same assignee. This description is incorporated herein by reference.

The device state 23 represents current status configuration of the device. The device state comprises the device state ID, Description, Current Value and Past Value. The device state Id is a unique identifier of the specific status state that the device state references. The device description is a clear definition of the state that is identified by the Device State ID. The Current Value is the Current Status value of the device. The past value is previous status value of the device. The device state history 24 stores the history of pass values of a device. The device state history comprises a date and a last value. The data is the date of historical record. The last value is the last value recorded on that date.

The second component of the system illustrated in FIG. 2 for which the present invention can perform analysis is the Security system 25. The security system defines what devices a particular user to in the system can access when attempting to access and communicate with each device in the system. The details of this security system are described in a co-pending patent application number AUS920020130US1, the contents are incorporated herein by reference. The components of the security system include users 26, roles 27, user session state information 28, message origin and destination 29, device privileges 30, role device privileges 31, and privileges 32.

The user 26 can be defined as a person, system, process, device manufacturer or any other entity that has the ability to transmit messages across the system. The user ID uniquely identifies the user (person, system, process, manufacturer, etc.) Each person is assigned a security role. A role 27 is assigned privileges from zero, one or many devices per device attribute. A role could be a systems administrator. The role ID uniquely identifies the specific role assigned to a user. A system administrator or other user would have a given user identity and assigned role. Each user has a session state 28 that tells the security system the activity of a user at any particular time. The user session state associates a user with access to a device for the duration of an approved message transaction. The user session ID uniquely identifies the user session state record. The message origin destination 29 controls the entrance of a message into the system. This element serves to protect the system from unauthorized entrance into the system similar to a firewall function. Message units contain the delivery address of devices on the network. These delivery addresses are used for auditing purposes. A message origin destination ID uniquely identifies the message origin destination record. The origin address identifies the source of the sender of the message. The destination address identifies the intended destination of the message.

Each user can have device privileges allocated to it for each device to enable the user to control that device. A device privilege 30 can contain one or more groups of privileges. The groups of privileges can be made up of one or more roles. A user that is a role of system administrator would have more privileges for a device than a user that has a role as an air conditioning engineer for that same device. In the example of an air conditioning system, the system administrator would have privileges change settings, adjust temperature controls or to perform any function the administrator desires. However, the engineer would have privileges that would only allow the engineer access to the air conditioner unit for the purpose of performing some maintenance activities. The engineer would not have the privilege to adjust the temperature controls for the air conditioner unit. In FIG. 2, the role device privileges box 31 is assigned privileges in a device associated with a defined role. The role device ID identifies that specific role. The description is a clear definition of what that Role Privilege of that device means as it categorized by it usage (i.e. maintenance is allowed on the device.). Device privileges 30 are a group of actions that can be performed by a device on the system. In an example, the actions for a videocassette recorder can be ‘play’, ‘record’, ‘fast-forward’, ‘rewind’, ‘stop’ and ‘eject’. Privileges 32 are the actions of the device (device privileges) that can be changed on a device. The privilege ID uniquely defines the definition. In many cases all of the device actions would be privileges. As previously stated, the role device privileges are the privileges that are available to a particular type of user (role).

With reference to the present invention, the activities of the security system would also be recorded at the central manager. Anytime a message is sent from one device to another device, there would a security check to determine whether that particular communication is within the defined privileges of the sending and receiving devices. Each security check could be recorded. In the alternative, there could be a recording of security checks only for specific types of devices. Each message sent or received by a device would have a corresponding record in the storage location that would contain the origin of the message, the destination of the message and the type of message content. This data would be collected, recorded and stored in a manner similar to the status change data for each device on the system. Analysis performed on the security data could show various types of users and the types of activities that are occurring on the system for a specified time period.

The third component of the system illustrated in FIG. 2 for which the present invention can perform analysis is the workflow creation and management 33. The workflow management component 33 manages the set of scenarios, which represent the collective usage pattern of one or more devices by a user (refer to user definition under security). The components of workflow management are usage 34, device usage 35, scenario 36, workflow 37 and workflow session 38. The usage parameter 34 is a default generic intent of a sensor, component or device. The usage ID defined the usage record. The description is the usage definition (i.e. temperature sensor). The Device Usage parameter 35 is the actual usage of device. The device usage ID uniquely defines the device usage record. The description defines the actual device usage in words such as fire detector. The Scenario 36 is a user defined device usage pattern. The Scenario ID defines the scenario record. The Workflow 37 is a user-defined sequence of scenarios. The Workflow ID defines the workflow record. The Sequence Number identifies what sequence this workflow is executed, when there is more than one workflow defined. The description accurately defines the workflow intent. The Workflow Session 38 manages the existence of an executing workflow(s). The Workflow Session ID defines the record, which represent the life of an executing workflow.

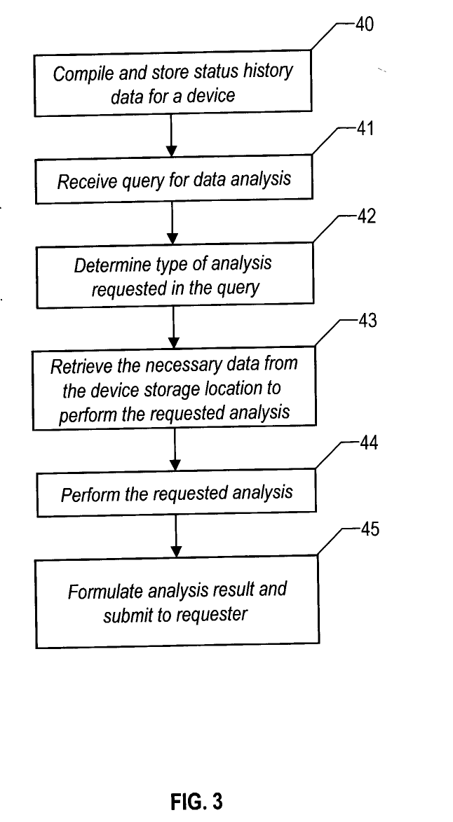

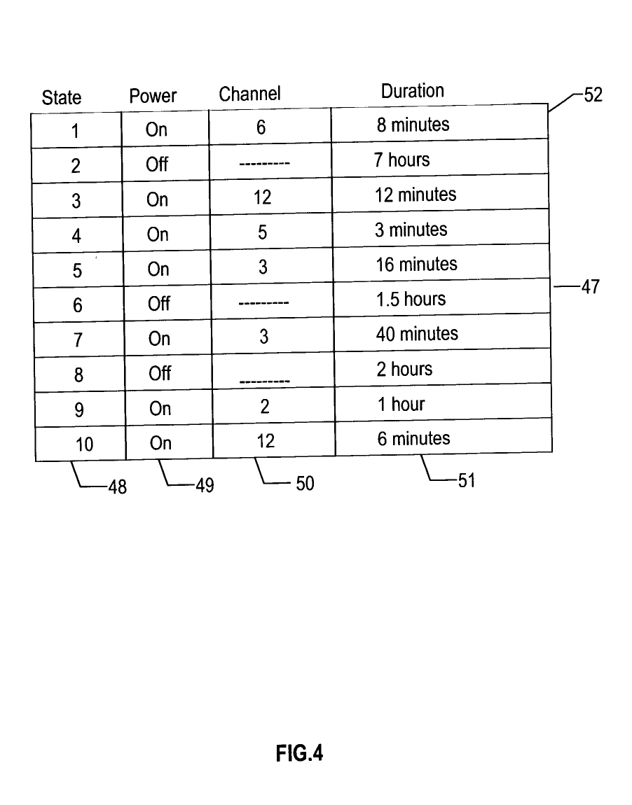

FIG. 3 shows a flow diagram of the steps in the preferred embodiment of the present invention. As shown, the initial step 40 is the collection and storage of the information for a particular device. The collection of the data comprises a collection of present and past status information for the device. The table in FIG. 4 is an example of the status information recorded for a television set during a period of 24 hours. In this configuration 47, there are a total of 10 status entries. The first field 48 lists the number of each state. The second field 49 lists the current power status of the device. Field 50 is the channel of the television. The fourth field 51 is the duration of the particular status. Although not shown, the table in FIG. 4 could contain “on time” and “off time” fields. The information in these fields would be used to calculate the duration attribute 51. An alternate table could also include “on time” and “off time” attributes and not the duration attribute. The decision would be in the discretion of the network designer. In this example, the first record 52 is the current status of the device. The record shows that the current status of the device is “on” and set to channel 6. The device has been set to channel 6 for eight minutes. If the owner of the facility accesses the system and wants to view the television device, the system would display this status history. The information in the status history can display as many attributes as the owner desires with respect to the particular device. In addition, the status history can vary with respect to the number of status entries that are to be maintained for a device. For example, the status history may be maintained for only the current day.

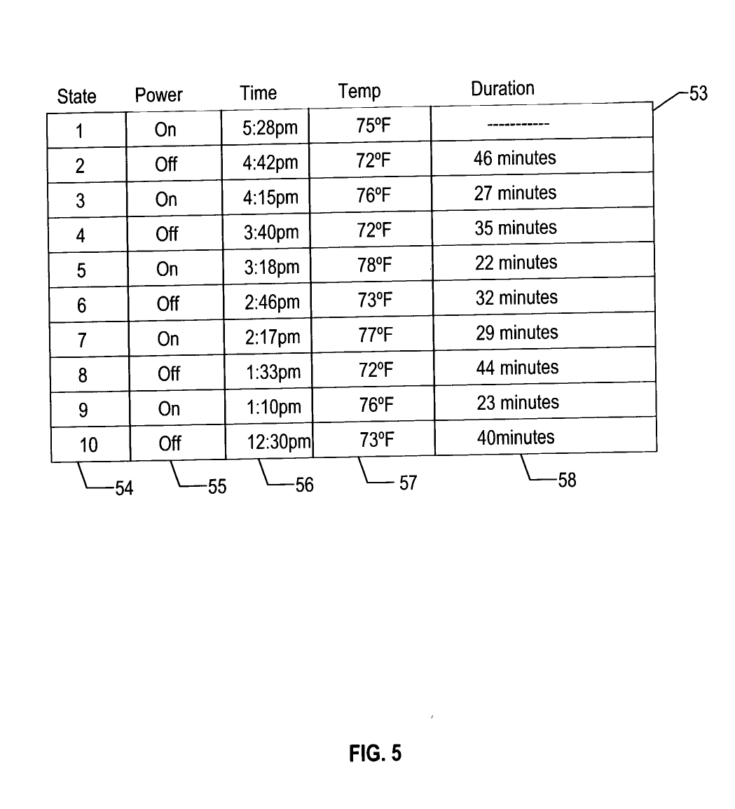

FIG. 5 shows another example of data stored for a system device. This example contains a status history 53 of an air conditioning unit. This information could describe the operation of a central air conditioning/heating system with a configuration that is similar to the systems in many commercial buildings or residential homes. The recorded data can be stored in a format and can comprise attributes such device state 54, Power 55, Temperature 56, Time 57 and Duration 58. Again, referring to FIG. 5, the data for this device contains records of the ten most recent status changes for the air conditioning/heating unit. As with FIG. 4, “on time” and “off time” attributes can be included in addition to or in place the calculated duration attribute 58.

Referring again to FIG. 3, in step 41 the central controller receives a query request for an analysis of a device. This query will usually come from the facility owner or manager. The query would identify the device, the parameters required for the analysis and the desired results of the analysis. In the example shown in FIG. 6, the owner desires to know the amount of time the air conditioner device was on during the time period from 12 p.m. to 6 p.m. The query request would contain information that identified the device, the time parameter, the power parameter and the duration parameter. Since, the specific request did not involve the need for the temperature, the query did not include the temperature parameter. After receipt of the query request, in step 42, there is determination of the type of analysis that will be necessary to produce the desired results of the query. An analytical module that performs the analysis on the data could be designed to make this determination internally or to provide the inquirer with a list of options from which to choose the type of analysis that the inquirer desires. In this example, the user wanted to know the amount of time the device was in operation. In another query, the user may want to know the average temperature of the facility during a certain time period. Based on the type of information desired and the device parameters that are needed, this second query request could be performed through a different analytical module. Once there is a determination of the type of analysis that will be used to perform the query request, in step 43, the specific data for the analysis is retrieved from the device storage location.

The fifth step 44 is to perform the analysis on the recorded data as identified in the query. To perform the analysis, there could be a standard analysis program tailored to perform analysis on this specific collection of compiled and stored data. As mentioned, another approach could be to have tailored analysis modules for each device in the system. These tailored modules could be routines that could generate results based on the use pattern of a particular parameter of the device. For example, in the case of usage pattern for an air conditioner, there would be a specific routine in the air conditioner module to generate usage results for the aid conditioner. In the above example, this module would take the information such as the power, time and duration parameters, and generate a usage pattern that would cover the time specified in the query. Following the analysis, step 45 formulates a result of the analysis to submit to the inquirer. The results could be presented or displayed in a form such as a graph, a plot, a chart or a written.

The unique state management system submitted in a previous patent, stores the current state of the devices attributes and it's past state history. When used in conjunction with this analysis and reporting model process, a goldmine of data and derived statistical information is created and made available. Device manufactures, consumer products and service organizations, advertisers, utility companies and many private and public agencies would find this information extremely valuable. This information gives insightful details on a device usage (as illustrated in the questions stated in the abstract of this document).

One example of this data's value is can be illustrated using a device such as a television or a radio. The information stored in the persistent repository could tell an inquirer the channel to which the television or radio is tuned, what time the user tuned to that channel, and how long the user stayed tuned to that channel.

There are many other examples that could be applied to any device. When the model is expanded to include device security information and Workflow Management information, (about explicit device usage, it's use and it's user in collaboration with other device in a defined routine pattern), the value of that information grows exponentially, as does the desired consumers of that information. The preferred version of this invention allows the user to mine data through the data infrastructure this model provides under the unique existence of a state management system, and apply analytical reasoning, based on the representation of that data mined.

The present invention provides benefits from the analysis of a unique set of data that was not previously available with convention types of data. The nature of the application of the present invention is such that various configurations of this invention can be implemented under the same concept described herein. While the description herein is one application of the invention, alternate applications can be designed by those skilled in the art that would also fall under the scope of the present invention. It is important to note that while the present invention has been described in the context of a fully functioning data communication system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for analyzing the operational characteristics of a device over a specified period of time comprising the steps of.
generating a history of the operation of a device by compiling a set of data on the operational status of a device, the data containing each status change of a device over a particular period of time, the status of a device comprising the particular state of one or more of the deice attributes at any time;
developing an operational characteristics query of the device based on the history of operation of one or more of the particular attributes of the device;
applying analytical processes to the compiled set of data based on the operational characteristics query to get a desired operational characteristic for the device; and
producing an operational characteristic of a device from the analytical processes.

2. The method as described in claim 1 wherein said operational history step further comprises:
receiving at the centralized manager a status change notification from one of the devices on the system;
identifying the specific device on the system that transmitted the status change notification; and
storing the status change information in the storage location for that specific device.

3. The method as described in claim 2 wherein said operational history step further comprises after said storing step, the step of updating the presently stored status information for the device transmitting the status change information.

4. The method as described in claim 3 wherein said stored status information comprises the past statuses of the device.

5. The method as described in claim 4 wherein said storing step comprises storing past statuses in a storage location in a chronological order.

6. The method as described in claim 5 further comprising the step of for calculating an attribute from past status information of a device and storing the calculated attribute in the storage location for that device.

7. The method as described in claim 4 wherein said generated operational history comprises a plurality of records, each record representing a unique status of the device at a period time having a current state, said record containing a present state field and a field for each designated attribute from that device that will initiate a status change for that device.

8. The method as described in claim 1 wherein said analytical process application step further comprises applying an analytical process dedicated to characterizing attributes from a particular device.

9. The method as described in claim 1 wherein said characteristic query developing step further comprising identifying the device attribute to be characterized and the length of time over which the analysis is to occur.

10. The method as described in claim 1 wherein said analytical process application step further comprises the step of retrieving information from the generated operational history for the device attributes to be used in the performance of the operational characteristics analysis.

11. A computer program product in a computer readable medium for analyzing the operational characteristics of a device over a specified period of time comprising:
instructions for generating a history of the operation of a device by compiling a set of data on the operational status of a device, the data containing each status change of a device over a particular period of time, the status of a device comprising the particular state of one or more of the deice attributes at any time;
instructions for developing an operational characteristics query of the device based on the history of operation of one or more of the particular attributes of the device;
instructions for applying analytical processes to the compiled set of data based on the operational characteristics query to get a desired operational characteristic for the device; and
instructions for producing an operational characteristic of a device from the analytical processes.

12. The computer program product as described in claim 11 wherein said operational history instructions further comprise:
instructions for receiving at the centralized manager a status change notification from one of the devices on the system;
instructions for identifying the specific device on the system that transmitted the status change notification; and
instructions for storing the status change information in the storage location for that specific device.

13. The computer program product as described in claim 12 wherein said operational history instructions further comprise after said storing instructions, instructions for updating the presently stored status information for the device transmitting the status change information.

14. The computer program product as described in claim 13 wherein said storing instructions comprise instructions for storing past statuses in a storage location in a chronological order.

15. The computer program product as described in claim 14 further comprising instructions for calculating an attribute from past status information of a device and storing the calculated duration in the storage location for that device.

16. The computer program product as described in claim 11 wherein said analytical process application instructions further comprise instructions for applying an analytical process dedicated to characterizing attributes from a particular device.

17. The computer program product as described in claim 11 wherein said characteristic query developing instructions further comprising instructions for identifying the device attribute to be characterized and the length of time over which the analysis is to occur.

18. The computer program product as described in claim 11 wherein said analytical process application instructions further comprise instructions for retrieving information from the generated operational history for the device attributes to be used in the performance of the operational characteristics analysis.
